(19) United States
(12) Patent Application Publication
(10) Pub. No.: US 2025/0173766 A1
(43) Pub. Date: May 29, 2025

(54) TEXT-BASED EMBEDDINGS OF TREATMENTS FOR WARM-STARTING UPLIFT MODELS

(71) Applicant: Maplebear Inc., San Francisco, CA (US)

(72) Inventors: Levi Boxell, Brownsburg, IN (US); Tilman Drerup, Berkeley, CA (US); Rustin Partow, San Francisco, CA (US)

(21) Appl. No.: 18/961,059

(22) Filed: Nov. 26, 2024

Related U.S. Application Data
(60) Provisional application No. 63/604,113, filed on Nov. 29, 2023.

(51) Int. Cl. G06Q 30/0241; G06N 20/00; G06Q 30/0242

(52) U.S. Cl. CPC G06Q 30/0276; G06N 20/00; G06Q 30/0243

(57) ABSTRACT

A system generates a set of embeddings for known treatments by applying a machine-learned embedding model to descriptions of the known treatments, where these embeddings form a vector space. The system generates an embedding for a new treatment and mapping it within the vector space, and identifies one or more known treatments with embeddings that exceed a similarity threshold with the new treatment embedding. The system accesses performance data for the selected known treatments to assess user response, and identifies a subset of users for the new treatment based on this performance data. The system also creates a content item that incorporates the new treatment, and transmits instructions to client devices of the targeted users to cause the client devices to display the content item.

### CROSS REFERENCE TO RELATED APPLICATION

This application claims the benefit of U.S. Provisional Patent Application Ser. No. 63/604,113, filed on Nov. 29, 2023, which is incorporated herein by reference in its entirety.

### BACKGROUND

Traditional methods of targeting treatments in software applications involve conducting A/B tests. An A/B test is a controlled experiment used in various fields, including marketing, product development, and user experience design, to compare two or more versions of treatments, such as an incentive, a coupon, or a marketing campaign, in order to determine which one performs better in terms of a specific goal or metric.

For example, users may be randomly separated into groups. Each group is exposed to its respective treatment or no treatment. During the test, performance data is collected on relevant metrics. These metrics could include click-through rates, conversion rates, sales, user engagement, or any other key performance indicators. Once a sufficient amount of data is collected, the results are analyzed to determine which treatment performed better for which user groups. Based on the results, an informed decision may be made.

Alternatively, or in addition, an uplift model may be trained based on the performance data to determine an incremental impact or “lift” that a specific treatment has on an individual user's behavior when compared to a control group. For example, an uplift model may be trained to determine which individual users are more likely to respond positively to a treatment compared to not receiving the treatment. An online service may provide the treatment to individual users who are more likely to respond positively, and not provide the treatment to individual users who are more likely to respond negatively.

Running A/B tests to gather performance data and subsequently training uplift models with this data can prove to be resource-intensive and time-consuming. Additionally, there's the possibility that randomly selected users in the A/B test, who received the treatment, may not exhibit a positive response. In such cases, these users might even find the A/B test to be bothersome.

### SUMMARY

Embodiments described herein relate to an online system that solves the above-described problem by mapping existing treatments into a vector space based on their respective descriptions. For a given new treatment, the new treatment can also be mapped into the vector space, and an existing treatment that is the most similar to the new treatment in the vector space may be selected. Alternatively, more than one existing treatment that is similar to the new treatment in the vector space may be identified, and a weighted combination of these “close” existing treatments may be used. The online system can then target a subset of users with the new treatment based on performance data of the selected existing treatment. As such, an A/B test is not required for the new treatment before targeting the subset of users.

In some embodiments, each of the known treatments is associated with a description. The online system applies a machine-learned embedding model to each description of the respective known treatment to output a set of embeddings (also referred to as “first embeddings”). The multiple first embeddings corresponding to the multiple existing treatments constitute a vector space.

For a given new treatment, the new treatment is also associated with a description. The online system applies the machine-learned embedding model to the description of the new treatment to output a second embedding. The second embedding can then be mapped to the vector space of the first embedding.

In some embodiments, the machine-learned embedding model is a pre-trained S-Bert model. In some embodiments, the machine-learned embedding model is further fine tuned based on performance data associated with the known treatments.

In some embodiments, the machine-learned embedding model is trained or fine tuned by applying the embedding model to a first description of a first known treatment to generate a first estimated embedding, applying the embedding model to a second description of a second known treatment to generate a second estimated embedding, computing a loss function that is dependent on a similarity between performance data associated with the first known treatment and performance data associated with the second known treatment, and updating parameters of the embedding model to reduce the loss function.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example of embedding space, in accordance with one or more embodiments.

FIG. 4 illustrates an example process for fine-tuning an embedding model, in accordance with one or more embodiments.

FIG. 5 is a flowchart for a method of targeting a subset of users with a new treatment based on performance data of known treatments, in accordance with one or more embodiments.

### DETAILED DESCRIPTION

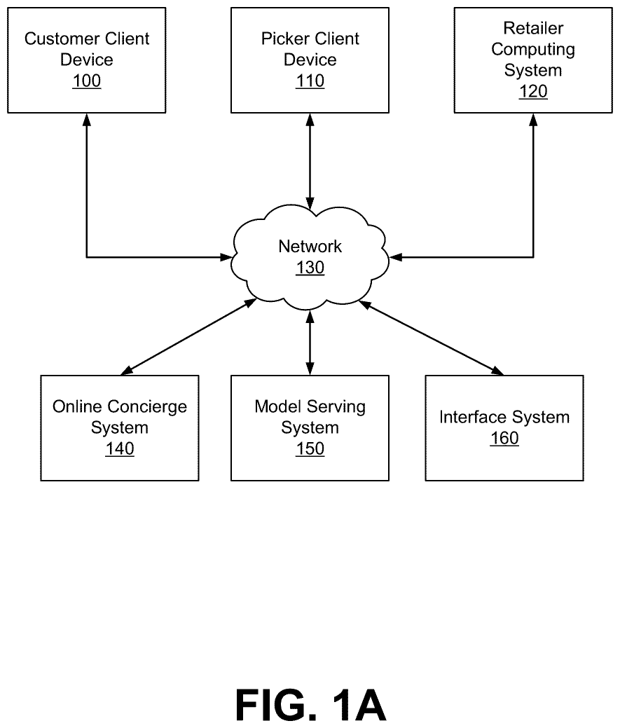

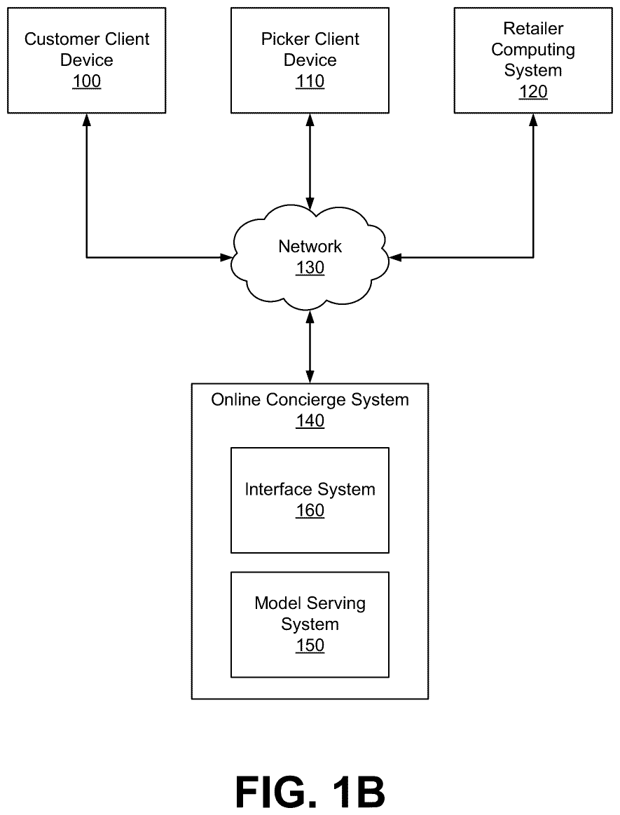

FIG. 1A illustrates an example system environment for an online system 140 (e.g., an online concierge system), in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provide portions of the payment from the customer to the picker and the retailer.

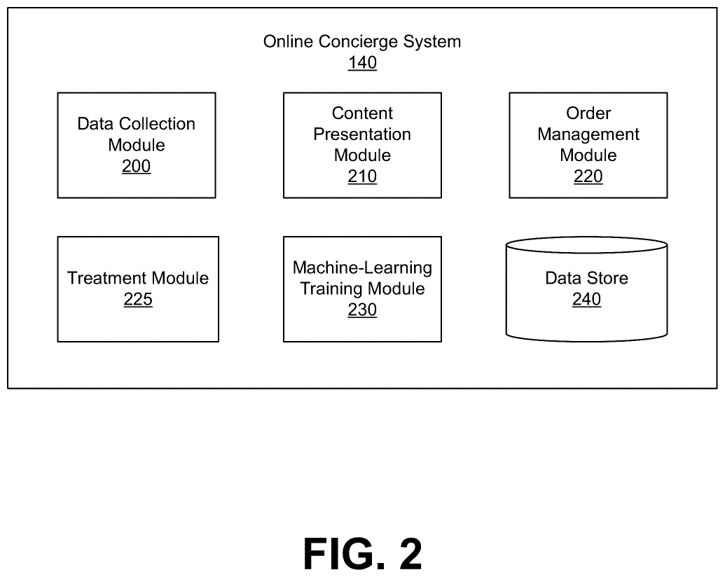

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

Thus, in one or more embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

In one or more embodiments, the online system 140 already has many treatments (also referred to as “known treatments”) that have been applied to users. For example, the online system 140 may store known treatments such as incentives (e.g., coupons) that encourage user actions to lead to desired outcomes, e.g., a click action, or a purchase action. Performance data may be obtained by applying each of the treatments to a subset of users, e.g., A/B tests. For example, for each of these treatments, the online system 140 may randomly provide the treatment to a subset of users, and determine performance or metrics of the treatment compared to the results associated with users who are not provided with the treatment.

In some embodiments, each of the known treatments is provided with a description, which may be a simple sentence, describing the treatment, e.g., “A $20 coupon off of a first-year annual membership of an online service.” The online system 140 applies a machine-learned embedding model to each description of the respective known treatment to output a plurality of first embeddings that constitute a vector space. In some embodiments, the sentences of the known treatments are mapped to a vector space. For example, given the sentence “A $20 coupon off of a first-year annual membership of an online service,” a numeric vector is created.

In some embodiments, the machine-learned embedding model may be based on a pre-trained Sentence-Bert (S-Bert). S-Bert is a type of natural language processing (NLP) model that is designed to create embeddings or numerical representations of sentences. It is based on transformer architecture and is particularly effective at capturing semantic meaning in sentences. S-Bert has been pre-trained on a large corpus of text and can generate fixed-length vectors for sentences in such a way that similar sentences have similar vector representations.

Alternatively, or in addition, the machine-learned embedding model may be further fine-tuned based on performance data of the prior treatments, e.g., the similarity of prior treatments' heterogeneous treatment effect distribution. Alternatively, or in addition, the machine-learned embedding model may be a Siamese network trained to generate treatment vector embeddings as well as user vector embeddings, which enables the determination of cross-product or cosine similarity, which in turn can serve as a predictive measure for user-level heterogeneous treatment effects (HTE).

When a new treatment is generated, the online system 140 may not have performance data for this new treatment. Traditionally, some kinds of tests (e.g., A/B tests) are applied to users to determine performance of the new treatment, which is time and resource-consuming. Unlike the traditional technologies, the online system 140 described herein applies the machine-learned embedding model to a description of the new treatment to output a second embedding, and maps the second embedding into the vector space of the first embeddings.

The online system 140 then compares the second embedding to the first embeddings in the vector space to select a known treatment corresponding to a first embedding that has a similarity to the second embedding above a predetermined threshold. In some embodiments, the similarity between a first embedding and the second embedding is determined based on a distance between the first embedding and the second embedding in the vector space. If the distance between the first embedding and the second embedding is below a predetermined threshold, the similarity between the first embedding and the second embedding is greater than the predetermined threshold. In some embodiments, the online system 140 selects a known treatment corresponding to a first embedding that is the most similar to the second embedding. For example, the online system 140 may select a known treatment corresponding to a first embedding that is the closest to the second embedding in the vector space. The online system 140 can then target a subset of users with the new treatment based on the performance data of the selected known treatment.

A notable benefit of this text-to-embedding mapping technique is its capacity to facilitate the exploration of prospective treatments and their anticipated uplift, all without the necessity of conducting real-world experiments. As an illustration, a user could feed various incentive concepts into the embedding process, pass the resulting embeddings into a pre-existing uplift model, and choose the incentive that is predicted to achieve the highest lift. The machine-learning uplift model is configured to receive an embedding describing a content of the new incentive and output predicted lift for one or more groups of users. By learning and deploying an embedding model that maps the new incentive into a latent space, the online system 140 can also input the embedding for the new incentive into the uplift model to predict likelihoods of lift across different groups of users. The new incentive may be presented to groups of users associated with lift predictions above a threshold.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a treatment module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In one or more embodiments, the data collection module 200 also collects communication data, which is different types of communication between shoppers and users of the online system 140. For example, the data collection module 200 may obtain text-based, audio-call, video-call based communications between different shoppers and users of the online system 140 as orders are submitted and fulfilled. The data collection module 200 may store the communication information by individual user, individual shopper, per geographical region, per subset of users having similar attributes, and the like.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In one or more embodiments, the content presentation module 210 receives one or more recommendations for presentation to the customer while the customer is engaged with the ordering interface. The list of ordered items of a customer may be referred to as a basket. As described in conjunction with FIGS. 1A and 1B, the recommendations are generated based on the inferred purpose of the basket of the customer and include one or more suggestions to the customer to better fulfill the purpose of the basket.

In one or more instances, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 210 may present the equivalent basket to the customer via the ordering interface with an indicator that states how an equivalent basket improves or is different from the existing basket (e.g., more cost-effective, healthier, sponsored by a certain organization). The content presentation module 210 may allow the customer to swap the existing basket with an equivalent basket.

In one instance, when the basket includes a list of edible ingredients, the recommendations are in the form of a list of potential recipes the ingredients can fulfill, and a list of additional ingredients to fulfill each recipe. The content presentation module 210 may present each suggested recipe and the list of additional ingredients for fulfilling the recipe to the customer. The content presentation module 210 may allow the customer to automatically place one or more additional ingredients in the basket of the customer.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

The treatment module 225 manages multiple treatments (also referred to as “known treatments”) that have been applied to users. In some embodiments, the treatment module 225 records performance of the multiple treatments in the data store 240. Each of the treatments includes a description. The description may be a text description or a sentence describing the corresponding treatment, e.g., ‘A $20 coupon off of the first year annual membership of an online service’, ‘A $70 coupon off of the first year annual membership of an online service’, ‘A $20 coupon off of orders of more than $75 from a retailer.’, ‘A $20 coupon off of orders of more than $75.’, ‘A $30 coupon for users who have not ordered in more than 30 days’, ‘A $20 coupon for new users’, etc.

The treatment module 225 applies a machine-learned embedding model to each description of the respective known treatment to output multiple embeddings that constitute a vector space. In some embodiments, the machine-learned embedding model may be based on a pre-trained S-Bert model. Alternatively, or in addition, the machine-learned embedding model may be further fine tuned based on performance data of the prior treatments, e.g., the similarity of prior treatments' heterogeneous treatment effect distribution.

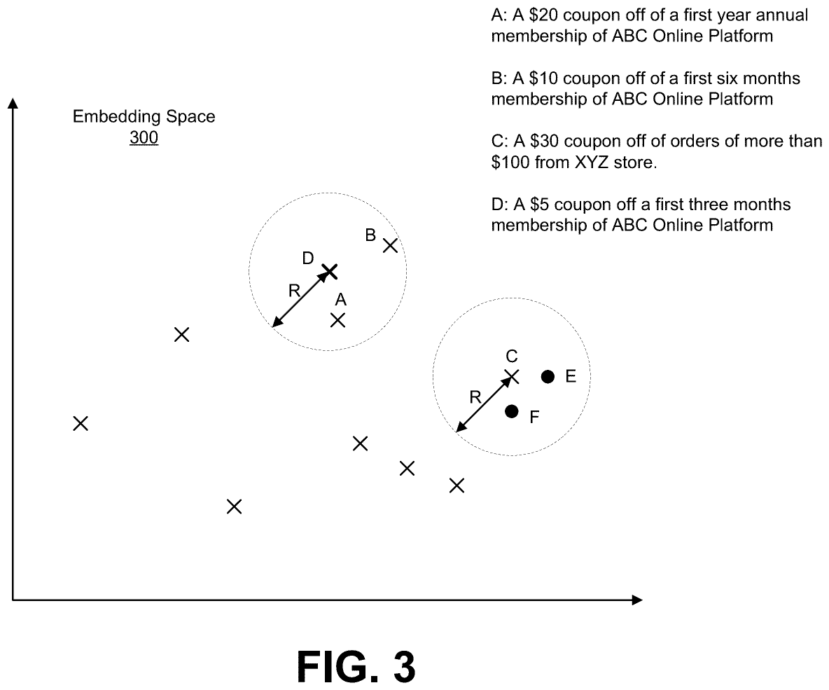

FIG. 3 illustrates an example embedding space 300, in accordance with one or more embodiments. Each embedding, representing a specific treatment, corresponds to a point within this embedding space 300. The embeddings are created by applying a machine-learned embedding model to each treatment's textual description. For example, treatment A, described as a “$20 coupon off a first-year annual membership of ABC online platform,” is mapped to point A (or embedding A) within embedding space 300. Similarly, treatment B, described as a “$10 coupon off the first six months membership of ABC online platform,” is mapped to point B (or embedding B), and treatment C, described as a “$30 coupon off orders over $100 from XYZ store,” is mapped to point C (or embedding C). Each point in embedding space 300 corresponds to a treatment with a descriptive text, and the distance between points indicates the level of similarity between treatments.

In some embodiments, a new treatment is generated and processed through a machine-learned embedding model to produce a new embedding. This new embedding is then compared with existing embeddings in the embedding space 300 to identify one or more existing embeddings that are within a specified similarity threshold. Performance data associated with these identified existing embeddings is retrieved and used to determine a target subset of users. The target subset of users may have shown positive responses to the identified known treatments corresponding to the existing embeddings and are likely to respond positively to the new treatment. The new treatment is subsequently applied to this target subset of users.

For example, a new treatment D, “a $5 coupon off a first three months membership of ABC Online Platform,” may be generated. The new treatment D is input into the machine-learned embedding model to output an embedding corresponding to point D in the embedding space 300. The embedding D is compared to the existing embeddings in the embedding space 300 to identify one or more embeddings (e.g., embeddings A and B) that are within a predetermined threshold distance R from the embedding D. The threshold distance R corresponds to a threshold similarity between the corresponding treatments. Notably, embeddings A and B correspond to treatments A and B. Since treatments A and B are existing treatments that have been applied to users in the past, the system can access their performance data, use this data to identify a subset of users who responded well to those treatments, and then target this subset of users with the new treatment D.

Alternatively, or in addition, the system 140 selects a known embedding (e.g., embedding C) within the embedding space 300. The system 140 then samples within a defined threshold distance (e.g., threshold distance R) from the selected known embedding C to generate one or more new embeddings, such as E and F. Based on these newly generated embeddings E and F, the system can create corresponding new treatments. Similarly, the system can access the performance data associated with the known embedding C, identify a target subset of users based on this performance data, and then target this subset of users with the new treatment E or F. The mapping from a new embedding to the content of a treatment (e.g., text of the treatment) can be generated by learning, for example, an inverse mapping from an embedding in the latent space to text, image, or video space (i.e., whichever data modality is used to generate the incentives).

Note, the embedding space 300 shown here is depicted as a two-dimensional space for simplicity and ease of illustration. This two-dimensional representation is merely an example to visualize the relationships between treatments. In practice, however, embedding space 300 may include any number of dimensions needed to capture the complex features and nuances of the treatments. The principles described herein can similarly be applied to identify similar treatments for any new treatment within an embedding space with more than two dimensions.

In some embodiments, the machine-learned embedding model may be a Siamese network trained to generate treatment vector embeddings as well as user vector embeddings, which enables the determination of cross-product or cosine similarity, which in turn can serve as a predictive measure for user-level heterogeneous treatment effects (HTE).

In some embodiments, a similarity score is determined for each pair of embeddings, and these similarity scores for all embedding pairs may be represented by a similarity matrix. An example similarity matrix is shown below.
[[1.00000024 0.96338737 0.57563674 0.59758085 0.53222752 0.62225401] [0.96338737 1.00000012 0.56376296 0.58320534 0.51309884 0.56858456] [0.57563674 0.56376296 1. 0.90712523 0.62764573 0.67078352] [0.59758085 0.58320534 0.90712523 1. 0.63238597 0.66703403] [0.53222752 0.51309884 0.62764573 0.63238597 1. 0.66221392] [0.62225401 0.56858456 0.67078352 0.66703403 0.66221392 1.00000012]]

Based on the similarity matrix, a similarity score of a first embedding and a second embedding is 0.96338737, indicating that the first and second embeddings are very similar; a similarity score of the first embedding and a third embedding is 0. 57563674, indicating that the first and third embeddings are somewhat similar, and so on and so forth.

When a new treatment is generated, no performance data is available for the new treatment. Traditionally, a test (e.g., A/B test) is applied to users to determine performance of the new treatment, which is time and resource-consuming. Unlike the traditional technologies, the treatment module 225 obtains a description of the new treatment, and applies the machine-learned embedding model to the description of the new treatment to output a new embedding.

The second embedding can then be mapped to the vector space of the embeddings of the known treatments. The treatment module 225 compares the new embedding to the previous embeddings of the known treatments in the vector space to select a known treatment with an embedding that has a similarity to the second embedding above a predetermined threshold.

In some embodiments, the treatment module 225 determines a similarity score between the new embedding and each of the previous embeddings, and selects a known treatment based on the similarity scores. Notably, in the vector space, embeddings that are in close proximity are indicative of greater similarity between them. Thus, in some embodiments, the treatment module 225 selects a known treatment corresponding to an embedding that is within a threshold distance to the new embedding in the vector space. In some embodiments, the treatment module 225 selects a known treatment corresponding to a first embedding that is the closest to the second embedding in the vector space.

The treatment module 225 can then target a subset of users with the new treatment based on the performance data of the selected known treatment. In some embodiments, each of the known treatments is associated with a machine-learned uplift model trained based on performance data associated with the respective known treatments. The treatment module 225 uses the uplift model associated with the selected known treatment to select the subset of users for receiving the new treatment. After applying the new treatment to the subset of users, the treatment module 225 would obtain performance data associated with the new treatment. Such performance data can then be used to fine-tune the uplift model.

In some embodiments, parameters of the embedding model are fine tuned by applying the embedding model to a first description of a first known treatment to generate a first estimated embedding, applying the embedding model to a second description of a second known treatment to generate a second estimated embedding, computing a loss function that is dependent on a similarity between performance data associated with the first known treatment and performance data associated with the second known treatment, and updating the parameters of the embedding model to reduce the loss function.

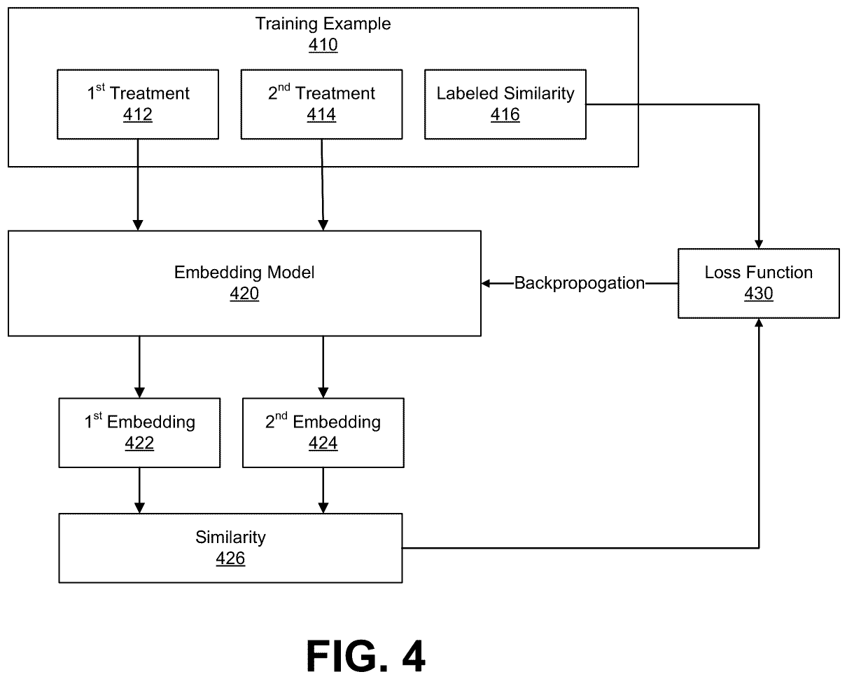

FIG. 4 illustrates an example process of fine-tuning an embedding model, in accordance with one or more embodiments. In some embodiments, fine-tuning is performed using training examples, each including a pair of treatments 412, 414 with a labeled similarity score 416. For example, a first treatment 412 may be “A $20 coupon off of the first year annual membership of ABC Online Platform”, a second treatment 414 may be “A $70 coupon off of the first year annual membership of ABC Online Platform”, and a labeled similarity score may be 0.8. As another example, a first treatment 412 may be “A $30 coupon off of orders of more than $100 from XYZ store”, a second treatment 414 may be “A $70 coupon off of the first year annual membership of ABC Online Platform”, and a labeled similarity score may be 0.3.

The first treatment 412 is input into an embedding model 420 to output a first embedding 422, and the second treatment 414 is input into the embedding model 420 to output a second embedding 424. The first embedding 422 and the second embedding 424 are compared to determine a similarity score 426. Referring back to FIG. 3, each embedding 422, 424 can be mapped onto the embedding space 300. A distance between the embeddings 422, 424 within the embedding space may be used to determine a similarity score between the embeddings 422, 424. In some embodiments, the similarity score is determined based on cosine similarity.

The labeled similarity score 416 and the predicted similarity score 426 are fed into a loss function 430 to calculate the loss, representing the difference between the ground truth (i.e., the labeled similarity score 416) and the model's prediction (i.e., the determined similarity score 426). In some embodiments, the loss function 430 calculates the difference between the predicted similarity score 426 and the labeled similarity score 416 to determine the loss value.

The embedding model 420 is penalized based on the loss, which represents the discrepancy between the predicted similarity score 426 and the labeled similarity score 416. Backpropagation may then be performed to compute the gradients of the loss with respect to each parameter of the embedding model 420. These gradients indicate the adjustments for each parameter to reduce the loss. The parameters are then updated accordingly, reducing the loss. This process is repeated for each batch of training examples. Over multiple epochs, the embedding model 420 is gradually fine-tuned to generate embeddings that more accurately capture the similarity relationships indicated by the labels in the training examples.

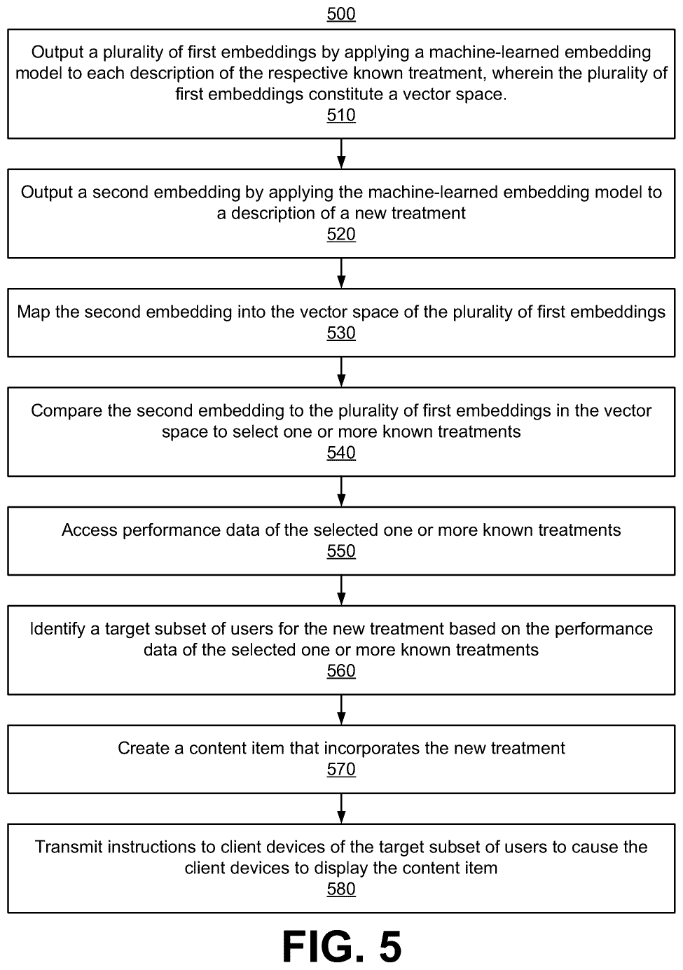

FIG. 5 is a flowchart for a method 500 of targeting a subset of users with a new treatment based on performance data of known treatments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The online system 140 outputs 510 a plurality of first embeddings by applying a machine-learned embedding model to each description of the respective known treatment. The plurality of first embeddings constitutes a vector space. In some embodiments, the description of a treatment is a sentence describing the treatment, e.g., ‘A $20 coupon off of the first year annual membership of an online service, ‘A $70 coupon off of the first year annual membership of an online service’, ‘A $20 coupon off of orders of more than $75 from a retailer.’, ‘A $20 coupon off of orders of more than $75.’, ‘A $30 coupon for users who have not ordered in more than 30 days’, ‘A $20 coupon for new users’, etc.

In some embodiments, the machine-learned embedding model may be based on a pre-trained S-Bert. Alternatively, or in addition, the machine-learned embedding model may be further fine tuned based on performance data of the prior treatments, e.g., the similarity of prior treatments' heterogeneous treatment effect distribution. In some embodiments, parameters of the embedding model are fine tuned by applying the embedding model to a first description of a first known treatment to generate a first estimated embedding, applying the embedding model to a second description of a second known treatment to generate a second estimated embedding, computing a loss function that is dependent on a similarity between performance data associated with the first known treatment and performance data associated with the second known treatment, and updating the parameters of the embedding model to reduce the loss function.

Alternatively, or in addition, the machine-learned embedding model may be a Siamese network trained to generate treatment vector embeddings as well as user vector embeddings, which enables the determination of cross-product or cosine similarity, which in turn can serve as a predictive measure for user-level heterogeneous treatment effects (HTE).

For a new treatment, the online system 140 outputs 520 a second embedding by applying the machine-learned embedding model to a description of the new treatment, and maps 530 the second embedding into the vector space of the plurality of first embeddings. The online system 140 then compares 540 the second embedding to the plurality of first embeddings in the vector space to select a known treatment corresponding to a first embedding that has a similarity to the second embedding above a predetermined threshold. In some embodiments, the online system 140 identifies a first embedding that is closest to the second embedding in the vector space, and selects a known treatment associated with the identified first embedding.

The online system 140 accesses 550 performance data for the one or more selected known treatments. The performance data is obtained based on applying the selected one or more known treatments to a plurality of users. The performance data may include (but is not limited to) information on how effective these treatments were with different user groups, such as response rates, purchase rates, or other engagement metrics.

The online system 140 identifies a target subset of users for the new treatment based on the performance data of the selected one or more known treatments. For example, the online system 140 may identify a target subset of users who respond well to the selected one or more treatments. The target subset of users may be identified based on similar characteristics or behaviors. Since the selected known treatments are similar to the new treatment and have been previously tested with users, the online system 140 can predict how users are likely to respond to the new treatment by assessing this historical performance data. For example, if a $20 discount on a certain type of item was popular with users who frequently purchase groceries during a specific timeframe, and the new treatment offers a similar discount on that type of item, the online system 140 may choose a subset of users who are frequent grocery buyers within that timeframe as the target audience for the new treatment . . .

In some embodiments, the target subset of users are identified based on applying a machine-learned uplift model to the selected one or more known treatments. The uplift model is a predictive model that estimates the incremental impact of a treatment on different users. An uplift model works by estimating the difference in behavior between groups of users when exposed to a treatment versus when not exposed. For example, the uplift model may be applied to performance data of the selected one or more known treatments to determine impact of the one or more known treatments to users. In some embodiments, identifying the target subset of users is based on the impact of the one or more known treatments. In some embodiments, identifying the target subset of users includes identifying a target subset of users that had a positive response to the one or more known treatments.

The online system 140 also creates 570 a content item that incorporates the new treatment. The online system 140 then transmits 580 instructions to client devices of the target subset of users to cause the client devices to display the content item. The content item may include (but is not limited to) a coupon, an email, a text message, and/or a push notification on a mobile application. For example, a coupon may be a discount offer like “$20 off on orders over $75.” The coupon may be sent via a text message, a push notification on a mobile application, or an email. In some embodiments, an email, text message, or a push notification may further include a personalized message along with the coupon. As such, the online system 140 is able to target a subset of users with the new treatment without having to conduct an A/B test.

After targeting the subset of users with the new treatment, performance data associated with the new treatment may be obtained. In some embodiments, the online system 140 can then fine tune the machine-learned uplift model corresponding to the selected known treatment based on the performance data of the new treatment. In this manner, by generating embeddings for treatments for which the performance is unknown, the online system 140 can deploy the new treatment with warm-start to reduce inefficient spend.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
outputting a plurality of first embeddings by applying a machine-learned embedding model to descriptions of a plurality of known treatments, wherein the plurality of first embeddings constitute a vector space;
outputting a second embedding by applying the machine-learned embedding model to a description of a new treatment;
mapping the second embedding into the vector space of the plurality of first embeddings;
comparing the second embedding to the plurality of first embeddings in the vector space to select one or more known treatments, each associated with a first embedding that has a similarity to the second embedding above a predetermined threshold;
accessing performance data of the selected one or more known treatments, the performance data obtained based on applying the selected one or more known treatments to a plurality of users;
identifying a target subset of users for the new treatment based on the performance data of the selected one or more known treatments;
creating a content item that incorporates the new treatment;
transmitting instructions to client devices of the target subset of users to cause the client devices to display the content item;
collecting user interactions from the client devices on the content item; and
retraining the machine-learned embedding model based on the user interactions.

2. The method of claim 1, wherein comparing the second embedding to the plurality of first embeddings in the vector space to select the one or more known treatments comprises:
identifying a first embedding that is closest to the second embedding in the vector space; and
selecting a known treatment associated with the identified first embedding.

3. The method of claim 1, wherein each of the known treatments corresponds a machine-learned uplift model trained based on the performance data of the respective known treatments, and
wherein targeting the subset of users with the new treatment based on the performance data of the selected known treatment includes selecting the subset of users by applying the machine-learned uplift model corresponding to the selected known treatment.

4. The method of claim 3, further comprising fine tuning the machine-learned uplift model corresponding to the selected known treatment based on performance data obtained by targeting the subset of users with the new treatment.

5. The method of claim 1, wherein parameters of the machine-learned embedding model are fine tuned by:
applying the machine-learned embedding model to a first description of a first known treatment to generate a first embedding in a pair of descriptions of known treatments;
applying the machine-learned embedding model to a second description of a second known treatment to generate a second embedding in the pair;
generating a loss based on a loss function that is dependent on a similarity between the first embedding and the second embedding; and
adjusting the parameters of the embedding model to reduce the loss.

6. The method of claim 5, wherein the pair of descriptions of known treatments are labeled with a similarity score indicating a degree of similarity between the first known treatment and the second known treatment, and wherein generating a loss based on the loss function includes:
generating a cosine similarity score of embeddings indicating a degree of similarity between the first embedding and the second embedding; and
generating the loss based on the loss function associated with a difference between the labeled similarity score and the cosine similarity score of the first embedding and the second embedding.

7. The method of claim 1, the method further comprising:
selecting a first embedding for a desired known treatment from the plurality of first embeddings;
sampling within a threshold distance from the first embedding to generate one or more third embeddings;
creating one or more third treatments based on one or more third embeddings; and
accessing performance data of the selected first embedding, the performance data obtained based on applying the desired known treatment corresponding to the selected first embedding to a plurality of users;
identifying a second target subset of users for the one or more third treatments based on the performance data of the desired known treatment corresponding to the selected first embedding;
creating a second content item that incorporates the one or more third treatments; and
transmitting instructions to client devices of the second target subset of users to cause the client devices to display the second content item.

8. The method of claim 1, wherein identifying a target subset of users includes applying an uplift model to performance data of the selected one or more known treatments to identify impact of the one or more known treatments to users; and
identifying the target subset of users based on the impact of the one or more known treatments.

9. The method of claim 8, wherein identifying the target subset of users includes identifying the target subset of users that had a positive response to the one or more known treatments.

10. A non-transitory computer-readable medium, having instructions encoded thereon that, when executed by one or more processors, cause the one or more processors to perform steps comprising:
outputting a plurality of first embeddings by applying a machine-learned embedding model to descriptions of a plurality of known treatments, wherein the plurality of first embeddings constitute a vector space;
outputting a second embedding by applying the machine-learned embedding model to a description of a new treatment;
mapping the second embedding into the vector space of the plurality of first embeddings;
comparing the second embedding to the plurality of first embeddings in the vector space to select one or more known treatments, each associated with a first embedding that has a similarity to the second embedding above a predetermined threshold;
accessing performance data of the selected one or more known treatments, the performance data obtained based on applying the selected one or more known treatments to a plurality of users;
identifying a target subset of users for the new treatment based on the performance data of the selected one or more known treatments;
creating a content item that incorporates the new treatment;
transmitting instructions to client devices of the target subset of users to cause the client devices to display the content item;
collecting user interactions from the client devices on the content item; and
retraining the machine-learned embedding model based on the user interactions.

11. The non-transitory computer-readable medium of claim 10, wherein comparing the second embedding to the plurality of first embeddings in the vector space to select the one or more known treatments comprises:
identifying a first embedding that is closest to the second embedding in the vector space; and
selecting a known treatment associated with the identified first embedding.

12. The non-transitory computer-readable medium of claim 10, wherein each of the known treatments corresponds a machine-learned uplift model trained based on the performance data of the respective known treatments, and
wherein targeting the subset of users with the new treatment based on the performance data of the selected known treatment includes selecting the subset of users by applying the machine-learned uplift model corresponding to the selected known treatment.

13. The non-transitory computer-readable medium of claim 12, further comprising fine tuning the machine-learned uplift model corresponding to the selected known treatment based on performance data obtained by targeting the subset of users with the new treatment.

14. The non-transitory computer-readable medium of claim 10, wherein parameters of the embedding model are fine tuned by:
applying the machine-learned embedding model to a first description of a first known treatment to generate a first embedding in a pair of descriptions of known treatments;
applying the machine-learned embedding model to a second description of a second known treatment to generate a second embedding in the pair;
generating a loss based on a loss function that is dependent on a similarity between the first embedding and the second embedding; and
adjusting the parameters of the embedding model to reduce the loss.

15. The non-transitory computer-readable medium of claim 14, wherein the pair of descriptions of known treatments are labeled with a similarity score indicating a degree of similarity between the first known treatment and the second known treatment, and wherein computing a loss based on the loss function includes:
generating a cosine similarity score of embeddings indicating a degree of similarity between the first embedding and the second embedding; and
generating the loss based on the loss function associated with a difference between the labeled similarity score and the cosine similarity score of the first embedding and the second embedding.

16. The non-transitory computer-readable medium of claim 10, the steps further comprising:
selecting a first embedding for a desired known treatment from the plurality of first embeddings;
sampling within a threshold distance from the first embedding to generate one or more third embeddings;
creating one or more third treatments based on one or more third embeddings; and
accessing performance data of the selected first embedding, the performance data obtained based on applying the desired known treatment corresponding to the selected first embedding to a plurality of users;
identifying a second target subset of users for the one or more third treatments based on the performance data of the desired known treatment corresponding to the selected first embedding;
creating a second content item that incorporates the one or more third treatments; and
transmitting instructions to client devices of the second target subset of users to cause the client devices to display the second content item.

17. The non-transitory computer-readable medium of claim 10, wherein identifying a target subset of users includes
applying an uplift model to performance data of the selected one or more known treatments to identify impact of the one or more known treatments to users; and
identifying the target subset of users based on the impact of the one or more known treatments.

18. The non-transitory computer-readable medium of claim 17, wherein identifying the target subset of users includes identifying the target subset of users that had a positive response to the one or more known treatments.

19. A computing system, comprising:
one or more processors; and
a non-transitory computer-readable medium, having instructions encoded thereon that, when executed by one or more processors, cause the one or more processors to perform steps comprising:
outputting a plurality of first embeddings by applying a machine-learned embedding model to descriptions of a plurality of known treatments, wherein the plurality of first embeddings constitute a vector space;
outputting a second embedding by applying the machine-learned embedding model to a description of a new treatment;
mapping the second embedding into the vector space of the plurality of first embeddings;
comparing the second embedding to the plurality of first embeddings in the vector space to select one or more known treatments, each associated with a first embedding that has a similarity to the second embedding above a predetermined threshold;
accessing performance data of the selected one or more known treatments, the performance data obtained based on applying the selected one or more known treatments to a plurality of users;
identifying a target subset of users for the new treatment based on the performance data of the selected one or more known treatments;
creating a content item that incorporates the new treatment;
transmitting instructions to client devices of the target subset of users to cause the client devices to display the content item;
collecting user interactions from the client devices on the content item; and
retraining the machine-learned embedding model based on the user interactions.

20. The computing system of claim 19, wherein comparing the second embedding to the plurality of first embeddings in the vector space to select the one or more known treatments comprises:
identifying a first embedding that is closest to the second embedding in the vector space; and
selecting a known treatment associated with the identified first embedding.
